(19) United States
(12) Patent Application Publication
(10) Pub. No.: US 2016/0118028 A1
(43) Pub. Date: Apr. 28, 2016

(54) Chinrest for Stringed Instruments

(71) Applicant: Randall W. OLSON, Bowling Green, KY (US)

(72) Inventor: Randall W. Olson, Bowling Green, KY (US)

(21) Appl. No.: 14/891,913

(22) PCT Filed: May 16, 2014
(86) PCT No.: PCT/US14/38458

§ 371 Date: Nov. 17, 2015

Related U.S. Application Data
(60) Provisional application No. 61/824,700, filed on May 17, 2013.

(51) Int. Cl. G10D 3/18

(52) U.S. Cl. CPC G10D 3/18

(57) ABSTRACT

Embodiments of the presently-disclosed subject matter include chinrests for stringed instruments. Exemplary chinrests can comprise a main body and a bracket for mounting the main body to the stringed instrument. In some embodiments the main body is comprised of a pad and one or more feet extending from a bottom surface of the pad. A chin plate for receiving a musician's chin can be defined by a top surface of the pad. Further, an extension portion of the pad can include an outer edge that extends beyond a back edge of the stringed instrument when the chinrest is mounted on the stringed instrument.

### RELATED APPLICATION

This application claims priority from U.S. Provisional Patent Application No. 61/824,700, filed May 17, 2013, the entire disclosure of which is incorporated herein by this reference.

### TECHNICAL FIELD

The presently-disclosed subject matter relates to stringed instruments. More particularly, embodiments of the presently-disclosed subject matter relate to chinrests for use with stringed instruments and methods for making and using the same.

### INTRODUCTION

Upper string players, including violin and viola players, have long used chinrests to facilitate ease in holding and playing their instruments. The instrument is held, in most cases, between the left jaw and the shoulder of the player. Therefore, according to standard practice, the player should rotate their head to bring the jaw into contact with the chinrest. Chinrests, however, present many difficulties in usage.

Known chinrests in their current configuration tend to follow the outline of the instrument, taking the chinrest away from the jaw. For example, FIG. 10 shows a top view of a stringed instrument (e.g., violin) that has a traditional chinrest 10 mounted thereto. Notably, the rear edge of the chinrest 10 follows or corresponds to the back edge 4 of the stringed instrument 1. This design forces the player to lean or stretch their head and neck to have sufficient contact with the chinrest and hold the instrument securely. This forced position can cause muscular tension and pain, resulting in decreased playing ability and possibly physical damage to the player.

Additionally, current chinrests contain a ridge that follows the outline of the instrument along the curve of the chinrest closest to the player's neck. This ridge forms a nearly right angle with respect to the player's jaw, and therefore can produce an uncomfortable pressure on the jaw. Also, screws or clamps that hold the chinrest to the instrument can protrude from the bottom edge of the instrument, and can cause discomfort to the player's neck and collarbone. Further still, the pressure from the chinrest feet can often mute the tone of the instrument.

To address these problems, many players place cushions of cloth or other materials on the chinrest in order to render it more comfortable, but chinrests lack a mechanism by which these cushions can stay firmly secured to the chinrest. Added to this, many players also customize their chinrests to match their individual body structures by raising or tilting their chinrests, but present chinrests often do not permit sufficient customization in shape. In particular, children who play stringed instruments can require differently-shaped chinrests due to the differences in body shapes at different ages, yet known chinrests for fractional-sized instruments are merely smaller scale versions of chinrests designed for full-sized players and instruments.

Hence, there remains a need for a chinrest that can reduce or eliminate the need for a musician to unduly extend their head and neck to contact the chinrest. Among other things, there also remains a need for a chinrest that meets the needs of musicians playing fractional-sized instruments.

### SUMMARY

This summary describes several embodiments of the presently-disclosed subject matter, and in many cases lists variations and permutations of these embodiments. This summary is merely exemplary of the numerous and varied embodiments. Mention of one or more representative features of a given embodiment is likewise exemplary. Such an embodiment can typically exist with or without the feature(s) mentioned; likewise, those features can be applied to other embodiments of the presently-disclosed subject matter, whether listed in this summary or not. To avoid excessive repetition, this summary does not list or suggest all possible combinations of features.

The presently-disclosed subject matter provides, in some embodiments, a chinrest for a stringed instrument. In some embodiments the chinrest can comprise a main body including a pad and one or more feet extending from a bottom surface of the pad, a chin plate defined by a top surface of the pad for receiving a chin, an extension portion of the pad including an outer edge that extends beyond a back edge of the stringed instrument when the chinrest is mounted on the stringed instrument, and a bracket extending from the main body and configured to mount the chinrest to the stringed instrument. In some embodiments the chinrest can include a material selected from wood, plastic, metal, and combinations thereof.

In some embodiments a chinrest is configured such that the outer edge of the extension is positioned behind a back end of the stringed instrument when the chinrest is mounted on the stringed instrument. Furthermore, in some embodiments the extension can extend from an entire portion of the pad that corresponds to the back edge of the stringed instrument.

The extension of the pad can have various forms and shapes. In some embodiments the outer edge of the extension is convex, in some embodiments a portion of the outer edge of the extension is concave, and in some embodiments the outer edge of the extension includes a smooth contour. In these or other embodiments, the extension can include an inner edge that corresponds to the back edge of the stringed instrument.

In certain embodiments the one or more feet can include a first foot and a second foot, and the first foot and the second foot can contact a top surface of the stringed instrument on each side of a tailpiece. In some embodiments comprising a first foot and a second foot, a surface area of a distal end of the first foot can be greater than a surface area of a distal end of the second foot. In other embodiments the chinrest can comprise one foot, and such embodiments can optionally comprise a foot that includes a shape that corresponds to the back edge of the stringed instrument.

Embodiments of chinrests can comprise one or more feet, wherein a distal end of the one or more feet can include a surface that is substantially parallel with the top surface of the pad. Furthermore, in some embodiments the chinrests can comprise a gasket positioned on a distal end of the one or more feet, such as a cork gasket.

Some embodiments of chinrests can further comprise a notch configured to couple a cushion, directly or indirectly, to the chin plate. In some embodiments the notch is positioned on the main body.

The presently-disclosed subject matter further provides, in some embodiments, a chinrest comprising a pad that is comprised of a substantially flat plate, a chin plate defined by a top surface of the pad for receiving a chin, an extension that is comprised of a portion of the pad that extends beyond a back edge of the stringed instrument when the chinrest is mounted on the stringed instrument, and one or more feet extending from a bottom surface of the pad. Such embodiments can further comprise a bracket that extends from the pad, the one or more feet, or both, and the bracket can be configured to mount the chinrest to the stringed instrument. In such embodiments, the pad, the one or more feet, or both can also include a hole for receiving a top screw of the bracket. For instance, the hole can be positioned on the one or more feet.

### BRIEF DESCRIPTION OF THE DRAWINGS

FIG. 1 shows a top view of chinrest in accordance with an embodiment of the presently-disclosed subject matter that is mounted to a stringed instrument.

FIG. 2 shows a rear view of the chinrest mounted to the stringed instrument.

FIG. 3 shows a side view of the main body of the chinrest.

FIG. 4 shows the bracket of the chinrest.

FIG. 5 shows a perspective view of a wedge in accordance with an embodiment of the presently-disclosed subject matter.

FIG. 6 shows a cross-sectional view of the wedge.

FIG. 7 shows a side view of the main body of another embodiment of a chinrest.

FIG. 8 shows a top view of a chinrest in accordance with another embodiment of the presently-disclosed subject matter that is mounted to a stringed instrument.

FIG. 9 shows a top view of a chinrest in accordance with another embodiment of the presently-disclosed subject matter mounted to a stringed instrument.

FIG. 10 shows a top view of a chinrest mounted to a stringed instrument.

### DETAILED DESCRIPTION OF EXEMPLARY EMBODIMENTS

The details of one or more embodiments of the presently-disclosed subject matter are set forth in this document. Modifications to embodiments described in this document, and other embodiments, will be evident to those of ordinary skill in the art after a study of the information provided in this document. The information provided in this document, and particularly the specific details of the described exemplary embodiments, is provided primarily for clearness of understanding and no unnecessary limitations are to be understood therefrom. In case of conflict, the specification of this document, including definitions, will control.

Each example is provided by way of explanation of the present disclosure and is not a limitation thereon. In fact, it will be apparent to those skilled in the art that various modifications and variations can be made to the teachings of the present disclosure without departing from the scope of the disclosure. For instance, features illustrated or described as part of one embodiment can be used with another embodiment to yield a still further embodiment.

All references to singular characteristics or limitations of the present disclosure shall include the corresponding plural characteristic(s) or limitation(s) and vice versa, unless otherwise specified or clearly implied to the contrary by the context in which the reference is made.

All combinations of method or process steps as used herein can be performed in any order, unless otherwise specified or clearly implied to the contrary by the context in which the referenced combination is made.

The device and methods of the present disclosure, including components thereof, can comprise, consist of, or consist essentially of the elements and features of the embodiments described herein, as well as any additional or optional components or features described herein or otherwise useful.

The presently-disclosed subject matter relates to chinrests for stringed instruments that can provide increased comfort of the player, customization of the chinrest to meet the needs of the player, lessening of the chinrest's impact on the sound of the instrument, shaping of the chinrest to meet the needs of players of fractional-sized instruments, and combinations thereof. Those of ordinary skill in the art will appreciate other advantages of the presently-described chinrests upon reviewing this disclosure.

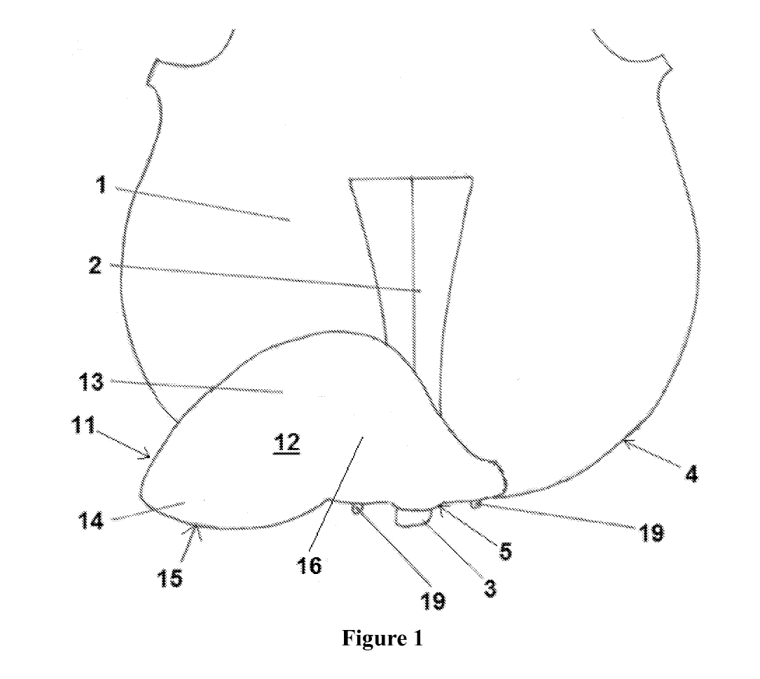

When referring to the chinrests and stringed instruments of the presently-disclosed subject matter, the orientation shown in FIG. 1 will be referenced. Thus, a back or lower end of the chinrest or stringed instrument corresponds to, respectively, a lower end side of the chinrest or stringed instrument as shown in FIG. 1.

In this regard, reference is made herein to a back edge 4 of a stringed instrument 1. The back edge 4 of a stringed instrument 1 corresponds to the back end of a stringed instrument as shown in FIG. 1 (i.e., a lower side as shown in FIG. 1). In some instances, a back edge 4 of a stringed instrument 1 specifically includes an edge formed by the lower portion of the instrument that substantially forms a half-circle, the back end 5 of the instrument 1 corresponding to the apex of the back edge 4. Furthermore, the stringed instruments 1 depicted herein include a tailpiece 2 that can be used to anchor strings (not shown) to the instrument 1. The tailpiece 2 can be coupled to the instrument by coupling a rear end of the tailpiece 2 to an end button 3 positioned at the back end 5 of the instrument.

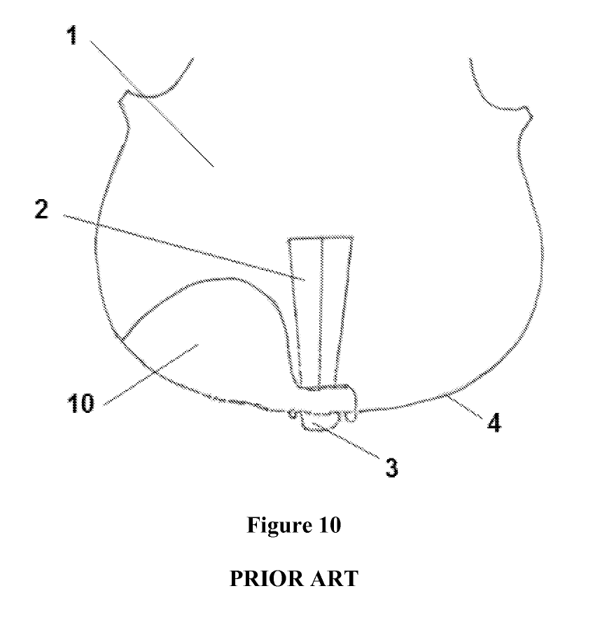

As shown in FIG. 10, current chinrests have an edge that corresponds to (i.e., follows the contour of) the back edge 4 of the instrument, thereby placing the chinrest far from the neck of a player. As a result, the chinrest is relatively far from the player's jaw line when the instrument is played. To compensate, players tend to tilt their heads, stretch their necks, and alter their shoulder position in various directions in an attempt to attain sufficient contact with the chinrest to hold the instrument securely. These motions result in physical pain, possible damage to the player, and detract from the player's playing ability.

Referring now to FIGS. 1 to 3, a top view, a bottom view, and a side view of an embodiment of the presently-disclosed chinrests that is mounted to a stringed instrument 1 are shown. The chinrest includes a main body 11 that includes a pad 13. The main body 11 also includes one or more feet 17 that extend from a bottom surface of the pad 13. When the chinrest is mounted to the instrument 1, the one or more feet 17 have distal ends that can contact a top surface of the instrument 1 directly or indirectly. For instance, in some embodiments the one or more feet 17 can directly contact a top surface of an instrument via their distal ends, and in other embodiments a foot gasket 18 can be coupled to the surface of some or all of the distal ends of the one or more feet 17. In some embodiments the gasket 18 can cover an entire distal end surface of a foot 17. The gasket 18 can, among other things, protect the surface of the instrument from abrasion and/or to reduce and negative effects the chinrest may have on the instrument's ability to produce a sound. In some instances the foot gasket 18 includes cork, rubber, or the like.

The two feet 17 of the embodied chinrest include distal ends comprising different surface areas. From the perspective shown in FIG. 3, the embodied chinrest includes a left foot 17 having a distal end that includes a larger surface area than the distal end of the right foot 17. In other embodiments the right foot 17 can include a distal end having a larger surface area than the distal end of the left foot 17. Thus, different embodiments of chinrests can have any number of feet that include the same or different distal end surface areas.

The surface areas of the feet distal ends can vary for a variety of reasons. The surface area may vary to accommodate certain stringed instruments and/or certain modifications to stringed instruments. Another concern with chinrests is that the clamping action of a chinrest to the instrument may reduce the vibrations of the instrument and thereby deaden the tone emitted by the instrument. In some embodiments wherein the right foot 17 of the chinrest is smaller than the left foot 17, the surface area of the feet 17 in contact with the instrument 1 can be reduced. This can limit the extent to which the chinrest, including the feet 17, may reduce vibrations and deaden the tone of an instrument 1.

FIG. 3 also shows that the two feet 17 are spaced apart from one another. In this manner, when the embodied chinrest is mounted to an instrument 1, the left foot 17 and the right foot 17 contact a top surface of the instrument 1 on either side of its tailpiece 2. The main body 11 of the chinrest is also configured such that a channel 23 is formed between the two feet 17. When the chinrest is mounted to the instrument 1, the tailpiece 2 can fit within the channel 23 without contacting the main body 11. Thus, the embodied chinrest is configured to be mounted above and around the tailpiece 2, but does not contact the tailpiece 2, which otherwise could affect the sound produced by the instrument 1.

Additionally, a top surface of the pad 13 defines a chin plate 12. The chin plate 12 is a portion of the pad 13 that a player can rest their chin, jaw, neck, or any other portion of the head on (collectively referred to as the chin herein) when playing the instrument 1. Thus, the chin plate 12 can include an entire top surface of a pad 13, or, in other embodiments, the chin plate 12 only includes a portion of the top surface of a pad 13. Furthermore, while the pad 13 can be comprised of a substantially flat plate having a substantially flat top surface, such pads 13 are inclusive of pads 13 that include a chin plate 12 having a concave contour. In some instances the concave contour of a chin plate 12 can help accommodate a player's chin. FIG. 3 shows that a portion of a substantially flat pad 13 includes a chin plate 12 with a concave top surface.

As stated above, the pad 13 also includes an extension 14 portion. The extension 14 includes an outer edge 15 that extends beyond the back edge 4 of the stringed instrument 1 when the chinrest is mounted to the instrument. For instance, as shown in FIG. 1, an outer edge 15 of the extension 14 is located outside a perimeter defined by the back edge 4 of the instrument 1.

The pad 13 also includes an interior portion 16 that includes the portion of the pad 13 that is located above the instrument 1 when the chinrest is mounted. In other words, the interior portion 16 of the pad 13 substantially corresponds in shape to certain known chinrests, and the extension 14 portion of the pad 13 is comprised of the portion of the pad 13 extending from the interior portion 16 beyond the back edge 4 of the instrument 1.

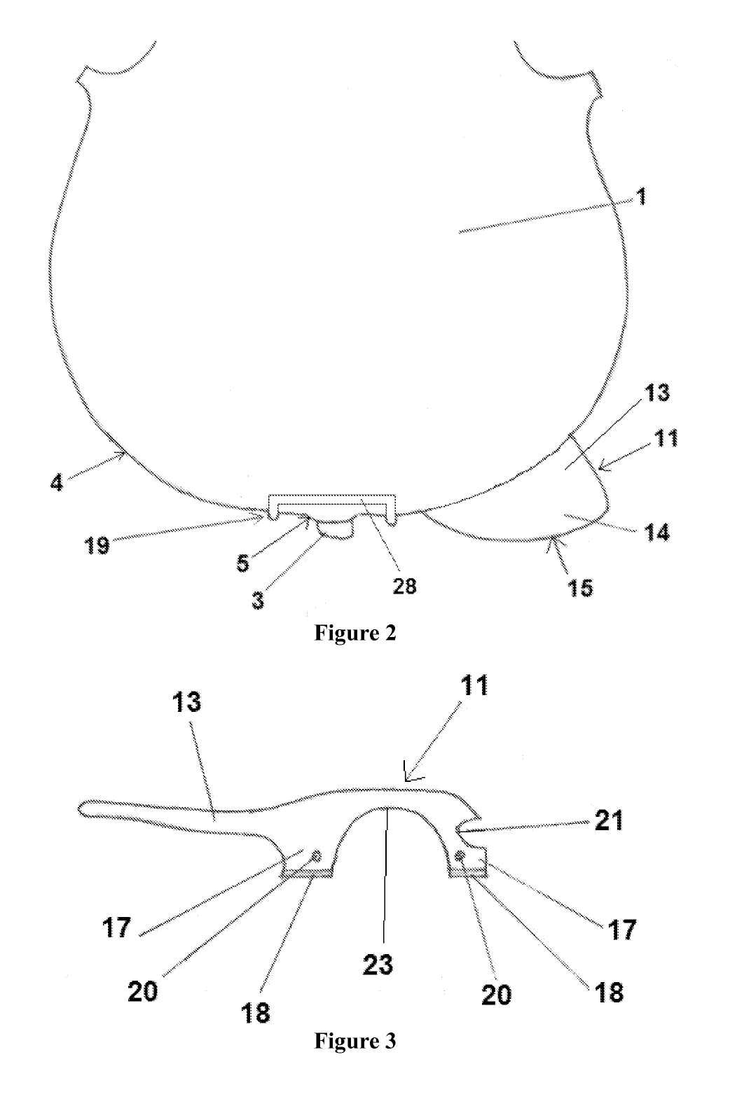

FIG. 2 shows a rear view of a stringed instrument 1 having a chinrest mounted thereto. The instrument 1 blocks the view of the portion of the pad 13 located above the instrument 1, or the interior portion 16 of the pad 13. Thus, FIG. 2 only shows a bottom surface of the extension 14 portion of the pad 13.

Since the extension 14 can extend towards a player's neck rather than merely follow the contour of the instrument 1, the contact area between the presently-disclosed chinrests and a player's chin can be increased relative to known chinrests mounted to instruments that are held in a comparable position. Thus, some embodiments permit a player to rotate their head toward the instrument and gain sufficient contact with the chinrest without the need for painful, damaging, and/or detrimental physical contortions, and allows for increased contact with the chinrest. In some embodiments, by virtue of having an extension 14, the chinrests can permit a player to maintain their head in its natural position while playing. Some embodiments also include an outer edge 15 having a flattened shape that can reduce or eliminate any uncomfortable pressure that may be created on a player's jaw, thereby reducing or eliminating a player's desire to tilt their head to avoid the sharp ridge typically found along the outer edge of known chinrests.

Additionally, some players prefer to place a cushion (not shown), such as a piece of cloth, a pillow, foam, or the like, on the chin plate 12 in order to render it more comfortable and/or raise the point of contact for the player's chin. In this regard, the present embodiment of the chinrest includes an optional notch 21 configured to couple a cushion to the chin plate 12. As shown in FIG. 3, the notch 21 can include a cut in a portion of the main body 11 that includes an approximately semicircular cross-sectional shape. The cut of the notch 21 can include a beveled shape and can include a concave indentation in the right foot 17 of the main body 11. A player can pass an attachment mechanism (not shown), such as a rubber band, string, strap, or the like, through the notch 21 and over the top of the main body 11 to secure a cushion to the chin plate 12. In some embodiments the notch 21 can be deep enough to hold a portion of the cushion in the notch 21.

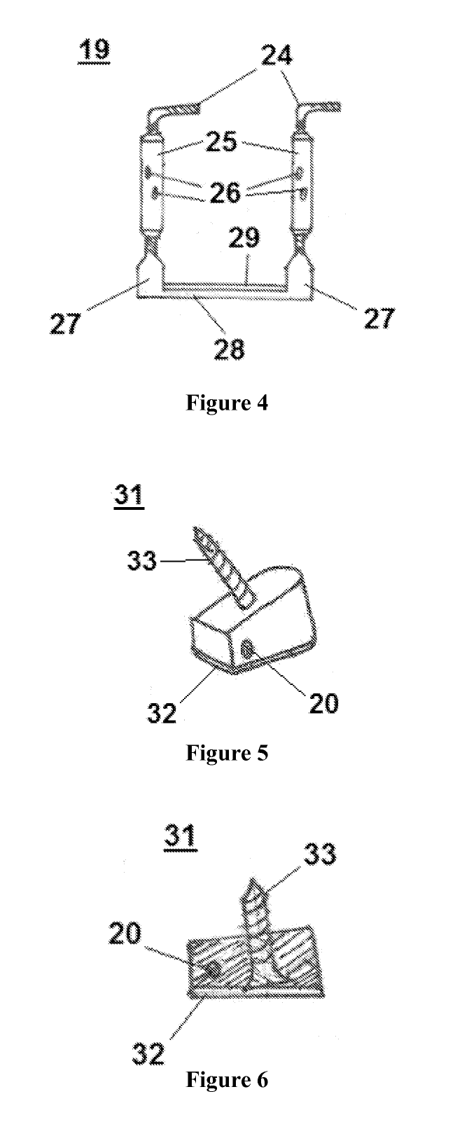

The presently-disclosed chinrests can also include a bracket 19 for mounting the chinrest, and specifically the main body 11, to an instrument 1. An exemplary bracket 19 is shown in FIG. 4. The bracket 19 includes a pair of top L-shaped screws 24 having two threaded ends for coupling the bracket 19 to the main body 11 of the chinrest. One end of the L-shaped screws 24 can be received by holes 20 provided on the main body 11. In some embodiments the holes 20 are provided on the pad 13, the feet 17, or a combination of the pad 13 and the feet 17.

A barrel 25 is coupled to the opposite ends of the L-shaped screws 24. The barrel 25 can include barrel holes 26 along its length. When mounting a chinrest, a rigid object, such as a chinrest key, can be inserted in the barrel holes 26 and can then be used to rotated the barrels 25 to shorten or elongate the bracket 19. A shank 27 is screwed into each end of the barrels 25 that are oppose from the L-shaped screws 24. The shanks 27 include a top portion that is threaded and can be screwed into the ends of the barrels 25. The shanks 27 also include a lower portion that is substantially flat, and a bottom support 28 is coupled to the lower portions of the shanks 27. In the illustrated embodiment the bottom support 28 is integral with the two shanks 27, and together they form one component. The bottom support 28 includes a surface that is perpendicular to a longitudinal direction of the barrels 25, and therefore the shanks 27 together with the bottom support 28 form a substantially L-shaped element. In this manner, when the bracket 19 is mounted to an instrument 1, the bottom support 28 can contact a bottom surface of the instrument 1 that is opposite the one or more feet 17 in contact with the top surface of the instrument 1.

Similar to the one or more feet 17, the bottom support 28 can contact the bottom surface of the instrument 1 directly or indirectly. For instance, the presently-described bracket 19 includes a gasket 29 covering a top surface of the bottom support 28 of the bracket 19. In this manner, when the bracket 19 is mounted to an instrument 1, the gasket 29 covering the bottom support 28 of the bracket 19 contacts the bottom surface of the instrument 1 and can protect it from abrasion and the like.

The present embodiment of a chinrest can further include flattened shanks 27 and/or a flattened bottom support 28 such that the portions of the bracket 19 that press against a player's neck, collar bone, and shoulders can cause less discomfort than brackets having sharper angles. In the present embodiment, the chinrest is configured such that lower portions of the shanks 27 that are proximate to the bottom support 28 are relatively wide and flat to eliminate some if not all of the potential pain caused by the bracket 19.

Looking now to FIGS. 5 and 6, wedges 31 that can be utilized in conjunction with the presently-described chinrests are illustrated. One or more wedges 31 can be placed under a foot 17. The wedges 31 can include a gasket 32 on a lower end side thereof, and the gasket 32 can be made of cork or the like. The wedges 31 can also include a wedge connection post 33, which may or may not be threaded. In some embodiments the wedge connection post 33 is fixed in the wedge 31, and in some embodiments the wedge connection post 33 include a screw that partially protrudes from a surface of the wedge 31. In this manner, the exemplary wedge 31 can be coupled to a distal end of a foot 17 to provide additional height to the foot 17. Additionally, the exemplary wedges 31 include a top surface and a bottom surface that are not parallel to one another so that when the chinrest is mounted the main body 11 can be tilted relative to the top surface of the instrument 1.

In this regard, wedges 31 can provide any degree of tilt to a main body 11. In some embodiments the wedges 31 are configured such that the back end of a main body 11 is lower than a front end of the main body 1, while in other embodiments the wedges 31 are configured such that the back end of a main body 11 is higher than a front end of the main body 1. In other embodiments the wedges 31 include a top surface and a bottom surface that are parallel, and the wedges 31 can thereby provide additional height to the feet 17 without altering the tilt of the main body 11.

The embodied wedges 31 are coupled to distal ends of the feet via a treated wedge connection post 28. However, the wedges 31 are not limited to this particular configuration. For instance, in other embodiments the wedges can be coupled to distal ends of the feet with two or more threaded or unthreaded wedge connection posts, an adhesive, a post that is received by a hole in the main body, combinations thereof, and the like. Those of ordinary skill will appreciate other configurations of wedges 31 as well as methods for coupling a wedge 31 to the distal end of a foot 17.

The wedges 31 can also comprise bracket holes 20 positioned on a side of the wedge 31. In embodiments where the main body 11 of the chinrest has been displaced by wedges 31, a bracket 19 can be coupled to the main body 11 by coupling the L-shaped screws 24 of the bracket 19 to the bracket holes 20 on the wedges 31.

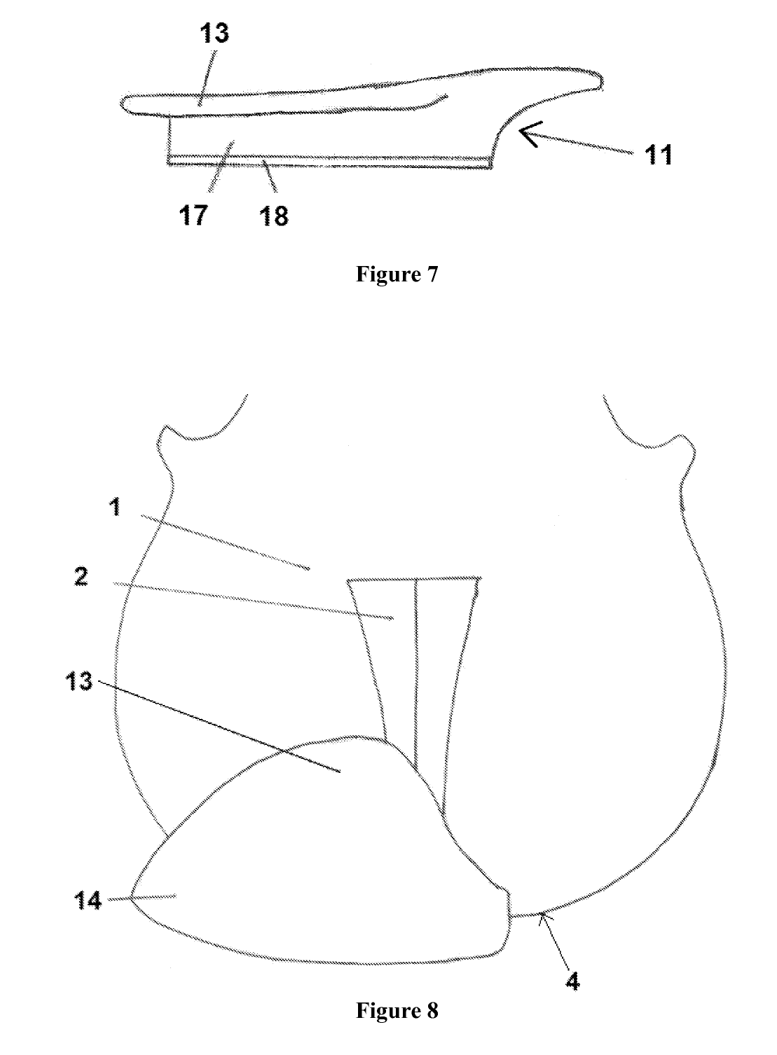

Although reference has been made to the particular embodiment illustrated in FIGS. 1 to 6, the presently-described chinrests should not be limited to the features of this embodiment. For example, as shown in FIG. 7, in some embodiments the chinrest can be constructed in what is known as a side-mounted style. This embedment includes a single foot 17 that extends along the bottom surface of the pad 13. In some embodiments comprising a single foot 17, the foot 17 includes a shape that corresponds to the back edge 4 of the stringed instrument 1. That is, the single foot 17 can include the same or similar shape or contour as the back edge 4 of the instrument 1. In some embodiments a gasket 18 is coupled to distal end of the single foot 17.

In some embodiments the chinrest is secured to the instrument 1 by what are known in the art as “Hill-Style” screws.

Further still, as shown in FIG. 8, in some embodiments the extension 14 of the pad 13 includes the entire back end of the pad 13. That is, the extension 14 can extend from the entire portion of the pad 13 that corresponds to the back edge 4 of the stringed instrument 1. In this manner, no portion of the pad's 13 edge will correspond to or follow the back edge 4 of the instrument 1. This or other embodiments can also include an extension 14 that is positioned behind a back end 5 of the instrument 1. Consequently, from the perspective shown in FIG. 1, at least a portion of the outer edge 15 of the extension 14 can be located below the back end 5 of the instrument 1. In some instances this configuration can bring the chinrest even closer to a player's head and reduce or eliminate the need for the player to unduly stretch their neck and head to have sufficient contact with the chin plate 12.

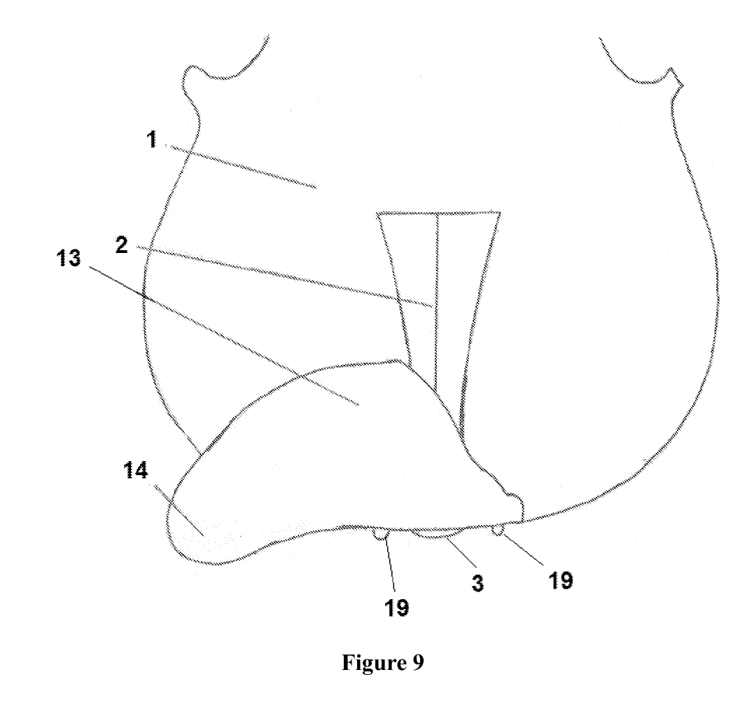

The contour of the outer edge 15 of the extension 14 can be varied to accommodate different players, instruments, or both. For instance, the above described embodiments all comprise an outer edge 15 of the extension 14 includes a partially or wholly convex shape. In other embodiments, such as the embodiment illustrated in FIG. 9, at least a portion of the outer edge 15 of the extension 14 can have a concave contour. Furthermore, some embodiments include an outer edge 15 of the extension 14 that consist of a smooth contour, while other embodiments can include an outer edge 15 that includes one or more corners.

Those of ordinary skill upon reviewing the present disclosure will recognize that the presently-described chinrests can also be altered in shape, size, height, angle, and the like to accommodate different players, preferences, instruments, and the like. For instance, one problem for stringed instrument players arises from the wide variety of face, jaw, chin, neck, and shoulder shapes that a player can have, which can make it difficult to fit a chinrest to a particular player. Therefore, the presently-described chinrests may be configured in varying heights, potentially by varying the height of the feet 17, the height of optional wedges 31, and/or adjusting the thickness of the pad 13. Variations can also be made to the angle of the pad 13, the distal ends of the one or more feet 17, and/or any wedges 31 to alter the angle or tilt of the chin plate 12 relative to a top surface of the instrument 1.

In some embodiments the chinrest is for fractional-sized stringed instruments. Fractional-sized instruments can be used by children and, as such, can be shaped differently to match the facial, neck, and body shapes of children. Common violin sizes include, but are not limited to, 1/64, 1/32, 1/16, 1/10, ⅛, ¼, ½, and ¾ sizes. Accommodations for some of these sizes include chinrests comprising a chin plate 12 that is relatively more centered over the tailpiece 2, which is where some children naturally place their chin when playing. As the size of the instrument increases, the chinrest can progressively be shifted so that the chin plate 12 is more to the left of the tailpiece 2. As instrument size increases, so can the height of the chin plate 12 relative to a top surface of the instrument 1 as well as the surface area of the chin plate 12.

Of course, some players hold instruments on their right shoulder instead of their left shoulder. Accordingly, in some embodiments, to accommodate such players, the chinrests may be constructed as a mirror image of the embodiments described herein.

What is claimed is:

1. A chinrest for a stringed instrument, comprising:
a main body including a pad and one or more feet extending from a bottom surface of the pad;
a chin plate defined by a top surface of the pad for receiving a chin;
an extension portion of the pad including an outer edge that extends beyond a back edge of the stringed instrument when the chinrest is mounted on the stringed instrument; and
a bracket extending from the main body and configured to mount the chinrest to the stringed instrument.

2. The chinrest of claim 1, wherein the outer edge of the extension is positioned behind a back end of the stringed instrument when the chinrest is mounted on the stringed instrument.

3. The chinrest of claim 1, wherein the extension extends from an entire portion of the pad that corresponds to the back edge of the stringed instrument.

4. The chinrest of claim 1, wherein the outer edge of the extension is convex.

5. The chinrest of claim 1, wherein a portion of the outer edge of the extension is concave.

6. The chinrest of claim 1, wherein the outer edge of the extension includes a smooth contour.

7. The chinrest of claim 1, wherein the extension includes an inner edge that corresponds to the back edge of the stringed instrument.

8. The chinrest of claim 1, wherein the chinrest includes a material selected from wood, plastic, metal, and combinations thereof.

9. The chinrest of claim 1, wherein:
the one or more feet include a first foot and a second foot, and
the first foot and the second foot can contact a top surface of the stringed instrument on each side of a tailpiece.

10. The chinrest of claim 1, comprising one foot.

11. The chinrest of claim 10, wherein the foot includes a shape that corresponds to the back edge of the stringed instrument.

12. The chinrest of claim 1, wherein:
the one or more feet include a first foot and a second foot, and
a surface area of a distal end of the first foot is greater than a surface area of a distal end of the second foot.

13. The chinrest of claim 1, wherein a distal end of the one or more feet includes a surface that is substantially parallel with the top surface of the pad.

14. The chinrest of claim 1, further comprising a gasket positioned on a distal end of the one or more feet.

15. The chinrest of claim 14, wherein the gasket includes cork.

16. The chinrest of claim 1, further comprising a notch configured to couple a cushion to the chin plate. The chinrest of claim 16, wherein the notch is positioned on the main body.

18. A chinrest for a stringed instrument, comprising:
a pad comprised of a substantially flat plate;
a chin plate defined by a top surface of the pad for receiving a chin;
an extension comprised of a portion of the pad that extends beyond a back edge of the stringed instrument when the chinrest is mounted on the stringed instrument; and
one or more feet extending from a bottom surface of the pad.

19. The chinrest of claim 18, further comprising a bracket extending from the pad, the one or more feet, or both, the bracket being configured to mount the chinrest to the stringed instrument.

20. The chinrest of claim 19, wherein the pad, the one or more feet, or both include a hole for receiving a top screw of the bracket.

21. The chinrest of claim 20, wherein the hole is positioned on the one or more feet.
